(19) United States
(12) Patent Application Publication
(10) Pub. No.: US 2022/0373372 A1
(43) Pub. Date: Nov. 24, 2022

(54) FLUID SENSOR FOR BUBBLE AND OCCLUSION DETECTION

(71) Applicant: Honeywell International Inc., Charlotte, NC (US)

(72) Inventors: Kuna Kishore, Bangalore (IN); Kumaran Narasimhan, Bangalore (IN); Manjunatha HM, Bangalore (IN); Varun Thakurta, Bangalore (IN); Abhishek Joshi, Bangalore (IN)

(73) Assignee: Honeywell International Inc., Charlotte, NC (US)

(21) Appl. No.: 17/324,187

(22) Filed: May 19, 2021

(51) Int. Cl. G01F 1/66

(52) U.S. Cl. CPC G01F 1/667; G01F 1/662

(57) ABSTRACT

A fluid sensor for monitoring a flow tube of a fluid flow system is provided. The fluid sensor comprises a housing to hold a portion of the flow tube, and the housing defines a first cavity, a second cavity, a first fixture and a second fixture. The fluid sensor comprises an ultrasonic transducer disposed within the first cavity and a force sensor disposed within the second cavity. The ultrasonic transducer has an emitting face to emit ultrasonic signals, and the emitting face is configured to face the portion of the flow tube. The first fixture extends along a boundary of the first cavity and the second fixture extends along a boundary of the second cavity.

### TECHNOLOGICAL FIELD

Example embodiments of the present disclosure relate generally to fluid sensors, and more particularly, to a fluid sensor for detecting bubbles and occlusion in an Intravenous (IV) tube.

### BACKGROUND

Fluid flow systems may be used in a multitude of applications in order to transport or otherwise move fluids from one location to another. In particular, the fluid flow systems may be incorporated as components of safety measures associated with intravenous infusions, a treatment measure in the daily routine of modern hospitals. Such fluid flow systems generally comprise an intravenous infusion device, such as a cannula or a catheter, for infusion of fluids, such as nutrients, blood and medication to a patient, one or more fluid sources for containing an intravenous fluid or a component thereof, and a fluid line assembly having an Intravenous (IV) tube providing fluid communication between the intravenous infusion device and the one or more fluid sources.

The fluid flow systems also include one or more sensors, such as fluid sensors to measure a precise amount of a fluid being delivered to the patient. The fluid flow systems may also comprise other sensors such as pressure sensors to detect fluid line blockage and ultrasonic sensors to detect air bubbles present in the IV tube.

### BRIEF SUMMARY

The illustrative embodiments of the present disclosure relate to a fluid sensor for detecting air bubble and occlusion in a fluid flow system. The fluid sensor comprises a housing configured to hold a portion of a flow tube. The housing defines a first cavity and a first fixture. The first fixture extends along a boundary of the first cavity. The fluid sensor further comprises an ultrasonic transducer housed within the first cavity, the ultrasonic transducer having an emitting face configured to emit ultrasonic signals, and the emitting face is configured to face the portion of the flow tube. The first fixture is configured to focus the ultrasonic signals on a region on the portion of the flow tube.

In an example embodiment, the housing defines a second cavity and a force sensor is housed within the second cavity. The force sensor has a receiving face configured to receive the ultrasonic signals for detecting a change in amplitude of the ultrasonic signals.

In an example embodiment, the housing defines a second fixture extending along a boundary of the second cavity. The second fixture is configured to focus the ultrasonic signals from the ultrasonic transducer on a region of a receiving face of the force sensor.

In an example embodiment, the housing defines a channel between the first cavity and the second cavity, wherein the channel is to receive the portion of the flow tube.

In an example embodiment, the emitting face of the ultrasonic transducer is spaced apart from the portion of the flow tube to collectively define a gap between the ultrasonic transducer and the flow tube, when the portion of the flow tube is received within the channel of the housing.

In an example embodiment, the receiving face of the force sensor is spaced apart from the portion of the flow tube to collectively define a gap between the force sensor and the flow tube, when the portion of the flow tube is received within the channel of the housing.

In an example embodiment, the fluid sensor comprises a cushioning element affixed to a portion of the housing, and the cushioning element is configured to hold the portion of the flow tube in the channel when the portion of the flow tube is received by the channel.

In an example embodiment, a fluid sensor comprises a housing defining a channel. The channel is configured to receive a portion of a flow tube and the housing comprises a first cavity. The fluid sensor comprises an ultrasonic transducer, housed within the first cavity, the ultrasonic transducer having an emitting face configured to emit ultrasonic signals, and the emitting face is configured to face the portion of the flow tube. The fluid sensor comprises a cushioning element affixed to a portion of the housing, and the cushioning element is configured to hold the portion of the flow tube in the channel when the channel receives the portion of the flow tube.

In some embodiments, the housing defines a second cavity, and a force sensor is housed within the second cavity. The force sensor has a receiving face configured to receive the ultrasonic signals for detecting a change in amplitude of the ultrasonic signals.

In an example embodiment, the emitting face of the ultrasonic transducer is spaced apart from the portion of the flow tube to collectively define a gap between the ultrasonic transducer and the flow tube, when the portion of the flow tube is received within the channel of the housing.

In some embodiments, the housing defines a first fixture extending along a boundary of the first cavity. The first fixture is configured to focus the ultrasonic signals on a region on the portion of the flow tube.

In an example embodiment, the housing defines a second fixture extending along a boundary of the second cavity, and the second fixture is configured to focus the ultrasonic signals propagated through the portion of the flow tube on a region of the receiving face of the force sensor.

In an example embodiment, the first fixture has a conical shape.

In an example embodiment, the emitting face of the ultrasonic transducer is spaced apart from the portion of the flow tube to collectively define a gap between the ultrasonic transducer and the flow tube, when the portion of the flow tube is received within the channel of the housing.

In an example embodiment, a fluid sensor comprises a housing defining a channel and a fixture, and the channel is configured to receive a portion of a flow tube. The fluid sensor comprises a force sensor disposed within the housing, the force sensor having a receiving face configured to receive ultrasonic signals for detecting a change in amplitude of the ultrasonic signals, and the ultrasonic signals propagate through the portion of the flow tube prior to receiving by the force sensor. The fixture is disposed adjacent the receiving face of the force sensor and the fixture is configured to focus the ultrasonic signals from the ultrasonic transducer on a region of the receiving face of the force sensor. The force sensor is to detect presence of an air bubble based on decrease in amplitude of the ultrasonic signals, and detect an occlusion based on increase in amplitude of the ultrasonic signals.

In some embodiments, the housing defines a first cavity and a second cavity on opposite sides of the channel. An ultrasonic transducer is disposed within the first cavity, the ultrasonic transducer having an emitting face configured to emit the ultrasonic signals, and the emitting face is configured to face the portion of the flow tube. The force sensor is disposed within the second cavity of the housing and the fixture is disposed along a boundary of the second cavity and the air bubble is a small sized bubble.

In various embodiments, the fluid sensor comprises a gel filling disposed in between the portion of the flow tube and the force sensor.

In an example embodiment, the fluid sensor comprises a cushioning element affixed to a portion of the housing, and the cushioning element is configured to hold the portion of the flow tube in the channel when the channel receives the portion of the flow tube.

In an example embodiment, the fixture has a conical shape.

In an example embodiment, the receiving face of the force sensor is spaced apart from the portion of the flow tube to collectively define a gap between the force sensor and the flow tube, when the portion of the flow tube is received within the channel of the housing.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIGS. 1A and 1B illustrate a perspective view and a top view of a fluid sensor, in accordance with an example embodiment of the present disclosure;

FIG. 2 illustrates a fluid sensor system with a controller, in accordance with an example embodiment of the present disclosure;

FIGS. 3A, 3B and 3C illustrate various sectional views of a fluid sensor, in accordance with an example embodiment of the present disclosure;

FIG. 4 illustrates an ultrasonic transducer for a fluid sensor, in accordance with an example embodiment of the present disclosure;

FIG. 5 illustrates a force sensor for a fluid sensor, in accordance with an example embodiment of the present disclosure;

FIG. 6 illustrates working of a fluid sensor, in accordance with an example embodiment of the present disclosure; and

FIG. 7 illustrates a graphical representation of an output signal sensed by a fluid sensor, in accordance with an example embodiment of the present disclosure; and

FIGS. 8A-8B illustrate various sectional views of another fluid sensor, in accordance with an example embodiment of the present disclosure; and

FIG. 9 illustrates a graphical representation of an output signal wave sensed by a fluid sensor, in accordance with an example embodiment of the present disclosure.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The terms “or” and “optionally” are used herein in both the alternative and conjunctive sense, unless otherwise indicated. The terms “illustrative” and “exemplary” are used to be examples with no indication of quality level. Like numbers refer to like elements throughout.

Fluid flow systems are used to deliver nutrients, saline or other life-saving fluids and medicines, in form of fluids, to patients through Intravenous (IV) tubes. The IV tubes are flexible plastic tubes having a predefined diameter and a hollow interior portion, and are often used along with a pump, such as a peristaltic pump. The pump provides pressure to push the fluids through the hollow interior portion of the IV tubes to be supplied to the patients. In such fluid flow systems, presence of other materials (e.g., air bubbles, debris, etc.) in the IV tubes or flow occlusion of the IV tubes resulting in increase of pressure inside the IV tubes may be detrimental to operation of the fluid flow systems. The presence of the other materials and the occlusion are also harmful to, for example, the patients.

The fluid flow systems have fluid sensors to monitor various parameters, such as pressure and rate of flow of the fluids flowing through the IV tubes. A fluid sensor detects the other materials in an IV tube based on radiations emitted by a transmitter of the fluid sensor that propagates through the IV tube and received by a receiver of the fluid sensor. The IV tube is in surface contact with the fluid sensor with the IV tube pressed against the transmitter and the receiver of the fluid sensor for detection of the radiations. However, with subtle movements of the IV tube during patient administration, the surface contact or contact area of the IV tube with the transmitter and the receiver varies causing unwanted variations in magnitude of radiations detected by the receiver and a corresponding output signal. Further, in an event of occlusion, the pressure inside the IV tube increases, and the surface of the IV tube becomes stiffer. The change in stiffness of the surface also affects the radiations and the corresponding output signal, as more radiations of higher magnitude are required to propagate through the IV tube to reach the receiver, when the surface is stiffer. This results in erroneous signal detection.

Additionally, due to prolonged flow of fluids through the IV tube, internal walls of the IV tube soften. Such changes in surface characteristics of the IV tube causes variations in signal detection and erroneous output signal. To this end, existing fluid sensors employ different sensors for detecting bubbles and occlusion and are not efficient in detecting bubbles due to varying contact area or surface characteristics of the IV tube. Further, existing fluid sensors are not efficient in detecting small sized bubbles. Many small sized bubbles present in the IV tubes remain undetected by the receiver of the fluid sensors, for such small sized bubbles do not fall within a field of view of the receiver. The fluid sensors may improperly detect and differentiate between medium sized and large sized bubbles. Such erroneous detection of bubbles may cause problems in the operation of the fluid sensors and to the patients.

Various example embodiments described in present disclosure relates to a fluid sensor of a fluid flow system for monitoring delivery of fluids to patients. The fluid sensor holds an IV tube or a flow tube and monitors a portion of the flow tube for various parameters such as flow rate, and pressure, bubbles and occlusion. The fluid sensor has an outer body or a housing that defines a space such as a channel to receive the portion of the flow tube. The housing has cavities, such as a first cavity and a second cavity disposed on opposite sides of the channel and different sensors are disposed within each cavity of the housing. In an example, an ultrasonic transducer is disposed in the first cavity and a force sensor is disposed within the second cavity. The ultrasonic transducer has an emitting face configured to emit ultrasonic signals and the ultrasonic transducer is placed within the first cavity such that the emitting face is faced towards the channel of the housing.

The force sensor has a receiving face that is faced towards the channel. In an example, the emitting face of the ultrasonic transducer and the receiving face of the force sensor are each spaced apart from the portion of the flow tube to collectively define a gap between the ultrasonic transducer and the flow tube, when the portion of the flow tube is received within the channel of the housing. The housing defines a fixture, such as a first fixture extending along a boundary of the first cavity and a second fixture disposed along a boundary of the second cavity. In an assembled state, when the fluid sensor holds the portion of the flow tube, the ultrasonic transducer and the force sensor are positioned such that ultrasonic signals emitted by the emitting face of the ultrasonic transducer propagates through the portion of the flow tube and are received by the receiving face of the force sensor. The first fixture allows focusing the ultrasonic signals on a region of the portion of the flow tube and the second fixture allows receiving of ultrasonic signals propagated from the portion of the flow tube. The force sensor receives the ultrasonic signals, detects variation in the ultrasonic signals and detects a bubble or an occlusion based on variations in the ultrasonic signals. In an example, a controller is coupled to the force sensor to process the ultrasonic signals received by the force sensor and process the signals to detect the bubble or the occlusion event.

The details regarding components of the fluid sensor and their working is described in detail with reference to subsequent figures.

The components illustrated in the figures represent components that may or may not be present in various example embodiments described herein such that embodiments may include fewer or more components than those shown in the figures while not departing from the scope of the disclosure.

Turning now to the drawings, the detailed description set forth below in connection with the appended drawings is intended as a description of various example configurations and is not intended to represent the only configurations in which the concepts described herein may be practiced. The detailed description includes specific details for the purpose of providing a thorough understanding of various concepts with like numerals denoting like components throughout the several views. However, it will be apparent to those skilled in the art of the present disclosure that these concepts may be practiced without these specific details.

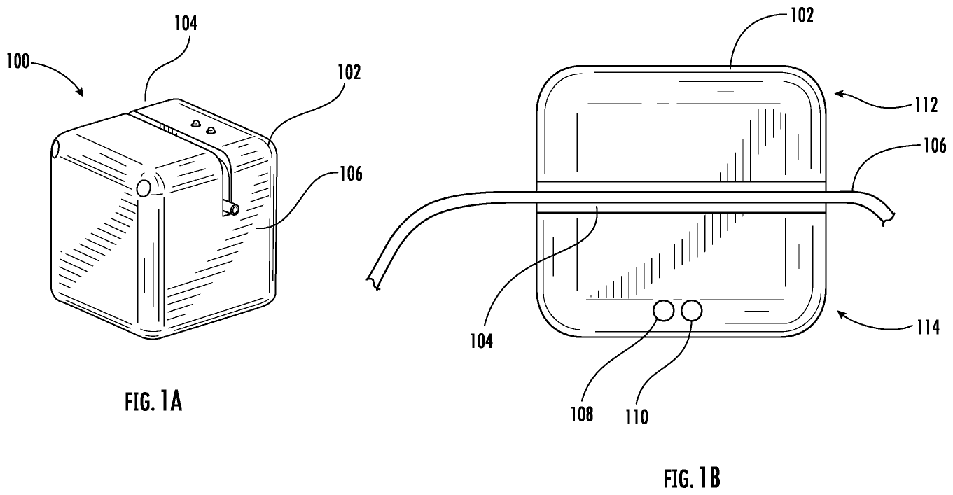

FIGS. 1A and 1B illustrate perspective and top views of a fluid sensor 100 of a fluid flow system, in accordance with an example embodiment of the present disclosure. As shown, the fluid sensor 100 has an outer body or a housing 102 defining a channel 104 to hold a flow tube 106. The fluid sensor 100 also comprises multiple indicators, such as indicators 108 and 110 on a top face of the housing 102. In an example, the housing 102 defines an exterior of the fluid sensor 100 and may have a height, length, and a width, wherein the length of the housing 102 is defined by a distance between a first end and a second end. The housing 102 defines a shape of the fluid sensor 100. For instance, the housing is a cube shown in the figure. The housing 102 can also have other shapes to fit into the fluid flow system.

The channel 104 is defined on the top face of the housing 102 and has a predefined width to receive the flow tube 106. As shown, the channel 104 is defined along a center region of the top face of the housing 102. The channel 104 divides the top face of the housing 102 into two parts, a first portion 112 and a second portion 114. Each of the first portion 112 and the second portion 114 houses a sensor as described in more detail with reference to subsequent figures. In various embodiments, the flow tube 106 has a length, and a diameter, and comprises an outer circumferential wall, an inner circumferential wall, and a wall thickness extending between the outer circumferential wall and the inner circumferential wall. In an example, the flow tube 106 defines an interior channel within the inner wall configured to direct the flow of fluid from one location to another location. The flow tube 106 may comprise a resilient material, for e.g., a silicone material, a polyvinyl chloride material, and/or the like. In an example, the indicators 108 and 110 glow with different colors to signal when a bubble is detected or a flow occlusion event is detected. For instance, the indicator 108 glowing with a red color indicates a bubble detected and the indicator 110 glowing with a red color indicates detection of the flow occlusion event. These signals for air bubble and flow occlusion are electrically communicated to a controller of the fluid flow system for control action as required by the fluid flow system.

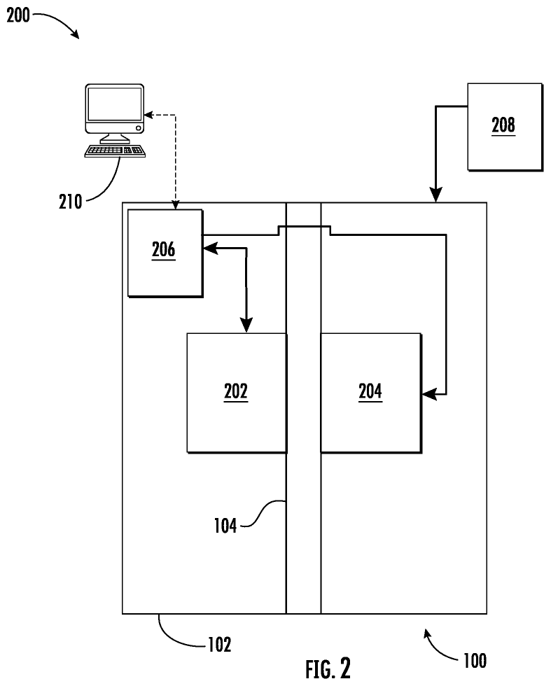

FIG. 2 illustrates a fluid sensor system 200, in accordance with an example embodiment of the present disclosure. The fluid sensor system 200 comprises an ultrasonic transducer 202, a force sensor 204 and a controller 206. The controller 206 coupled to both the ultrasonic transducer 202 and the force sensor 204. Further, the fluid sensor system 200 comprises a power supply 208 and a server or a computer 210.

As shown, the housing 102 comprises the channel 104 extending from the first end of the housing 102 to the second end and configured to receive and secure at least the portion of the flow tube 106. The housing 102 may be configured to enclose both the ultrasonic transducer 202 and the force sensor 204 within the interior portion of the housing 102. The ultrasonic transducer 202 and the force sensor 204 are each coupled to an interior portion of the housing 102 and are spaced apart within the interior portion of the housing 102 to define the channel 104 between the two sensors. The ultrasonic transducer 202 and the force sensor 204 of the illustrated embodiment are aligned within the housing 102 so as to face one another, that is, the emitting face of the ultrasonic transducer 202 is facing towards the receiving face of the force sensor 204 such that waves or signals generated by the ultrasonic transducer 202 and emitted from the emitting face of the ultrasonic transducer 202 travel towards the receiving face of the force sensor 204. In such an exemplary configuration, the ultrasonic transducer 202 and the force sensor 204 are arranged to face a direction perpendicular to the length of the channel 104, and may define at least a portion of the channel 104.

The power supply 208 is configured to receive power and power the fluid sensor 100. In an example, the power supply 208 may comprise one or more batteries, one or more capacitors, one or more constant power supplies, e.g., a wall-outlet, and/or the like. In an example, the power supply 208 may comprise an external power supply positioned outside the housing 102 and configured to deliver alternating or direct current power to the fluid sensor 100. In another example, the power supply 208 may comprise an internal power supply integrated within the fluid flow system, for example, one or more batteries, positioned within the housing 102, to obtain power from within the fluid flow system.

In various embodiments, power may be supplied to the controller 206 to enable distribution of power to the various components described herein. In some embodiments, each of the components of the fluid sensor 100 may be connected to controller 206 (e.g., for electronic communication), which may be configured to facilitate communication and functional control therebetween. In various embodiments, the controller 206 may comprise one or more of a processor, memory, a communication module, an on-board display, and signal analysis circuitry. For example, the controller 206 may comprise a driving circuit and a signal processing circuit. In various embodiments, the controller 206 may be configured to power the force sensor 204 and/or receive an output signal from the force sensor 204. In various embodiments, the controller 206 may be configured to power the ultrasonic transducer 202 and transmit a drive signal to the ultrasonic transducer 202. In various embodiments, the controller 206 may be configured to transmit output signals out to external components via universal serial bus (USB) or any other wired connection. In various embodiments, an on-board display may be configured to display a variety of signals transmitted from or received by the controller 206. In various embodiments, the controller 206 may be embodied as a single chip (e.g., a single integrated-circuit chip) configured to provide power signals to both the ultrasonic transducer 202 and the force sensor 204, to receive and process the output signal from the force sensor 204, and/or to compensate for any detected changes in environmental factors such as, for example, temperature, flow, or pressure within the flow tube 106. In an example, the controller 206 is configured so as to enable wireless communication within a network to a variety of wirelessly enabled devices, e.g., a user mobile device, a server or a computer 210, and/or the like.

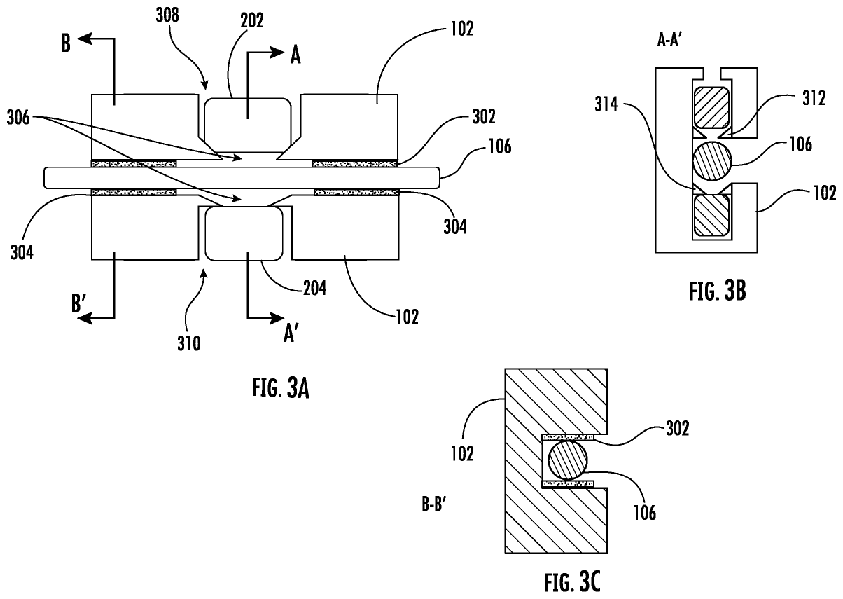

FIGS. 3A, 3B and 3C illustrate various cross-sectional views of the fluid sensor 100. As shown in FIGS. 3A-3C, the flow tube 106 is received within the channel 104 of the housing 102. The fluid sensor 100 comprises cushioning elements 302 and 304 affixed to portions of the housing 102 and disposed between the housing 102 and the portion of the flow tube 106. In an example, the cushioning elements 302 and 304 are aligned such that the cushioning elements 302 and 304 hold the flow tube 106 within the channel 104 and minimizes relative motion between the housing 102 and the flow tube 106. In an example, the cushioning element 302 allows the ultrasonic transducer 202 to be spaced apart from the portion of the flow tube 106 to collectively define a gap, such as the air gap 306 between the ultrasonic transducer 202 and the flow tube 106. The cushioning element 304 allows the force sensor 204 to be spaced apart from the portion of the flow tube 106 to define the air gap 306 between the force sensor 204 and the flow tube 106. The air gap 306 eliminates surface contact of the flow tube 106 with the ultrasonic transducer 202 and the force sensor 204. Therefore, subtle movements of the flow tube 106 during patient administration do not affect signal detection by the force sensor 204.

The fluid sensor 100 also defines a first cavity 308 and a second cavity 310. The ultrasonic transducer 202 is housed within the first cavity 308 and the force sensor 204 is housed within the second cavity 310.

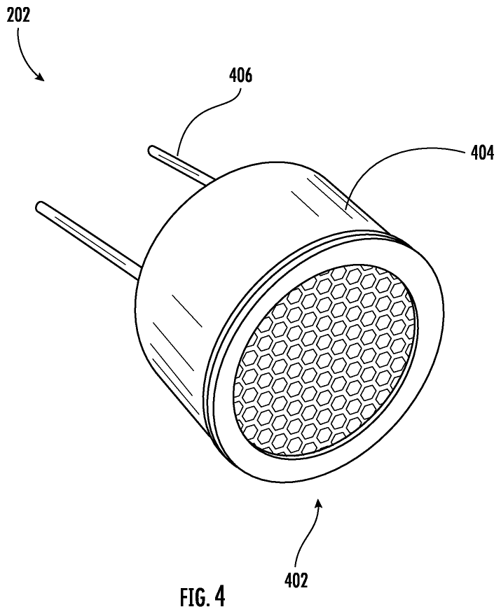

The ultrasonic transducer 202, as shown in FIG. 4, has an outer casing 404, and connectors 406 for electrical connection. The outer casing is circular in shape, as shown in the figure and may have other shapes based on the type and application of the ultrasonic transducer 202. The ultrasonic transducer 202 has an emitting face 402. The emitting face 402 emits ultrasonic signals. In an example, the ultrasonic transducer 202 is disposed within the first cavity 308 such that the emitting face 402 is aligned facing the channel 104. In an example, the ultrasonic transducer 202 is chosen for acoustic frequencies of less than 1 Mega Hertz (MHz) to match a dynamic response range of a selected force sensor, for instance, the force sensor 204. The ultrasonic transducer 202 has 10 millimeter (mm) diameter active area and operates in 300 Kilohertz (KHz) frequency at 10 Volts signal voltage.

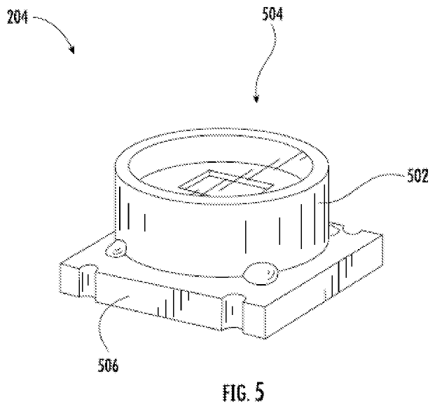

The force sensor 204, as shown in FIG. 5, has an outer body 502, and a base 506. The force sensor 204 has a receiving face 504 to receive ultrasonic signals emitted by the ultrasonic transducer 202. In an example, the force sensor 204 has a diaphragm, not shown in the figure, to receive the ultrasonic signals and detect the ultrasonic signals based on deformation of the diaphragm. In an example, the force sensor 204 is a gel-filled unamplified force sensor that operates in a pressure range of 0-600 Kilopascal (KPa). The force sensor 204 provides temperature compensated sense bridge output that is coupled to an external broad band amplifier.

Referring to FIGS. 3A-3C, the housing 102 defines a first fixture 312 disposed along the boundary of the first cavity 308 and a second fixture 314 disposed along the boundary of the second cavity 310. In an example, the first fixture 312 and the second fixture 314 are each coupled to the boundary of the first cavity 308 and the second cavity 310, respectively. In various embodiments, the first fixture 312 and the second fixture 314 may be separate parts having a particular shape or form designed to meet requirements of the fluid flow system. In an example, the first fixture 312 and the second fixture 314 are of conical shape. In an example, the first fixture 312 and the second fixture 314 are aligned such that the first fixture 312 allows focusing of the ultrasonic signals on a region of the flow tube 106 and the second fixture 314 allows focusing of the ultrasonic signals received by the force sensor 204 on the receiving face 504 of the force sensor 204. Such focusing of the ultrasonic waves by the first fixture 312 increases intensity of the waves on the region of the flow tube 106 and the second fixture 314 improves collection of ultrasonic waves for stronger signals to be detected by the force sensor 204. The focusing of the ultrasonic signals provides for reduced transmission losses of the ultrasonic signals and improved signal detection and processing by the force sensor 204.

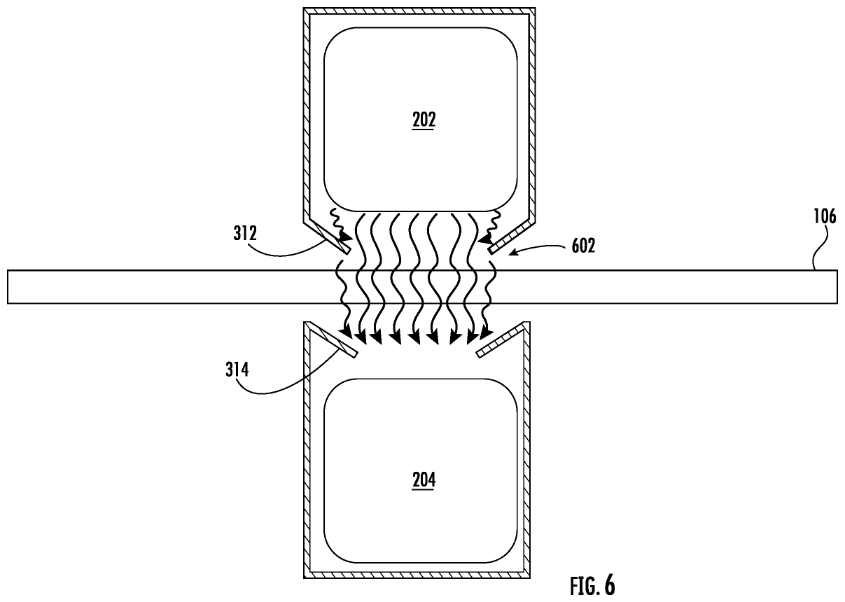

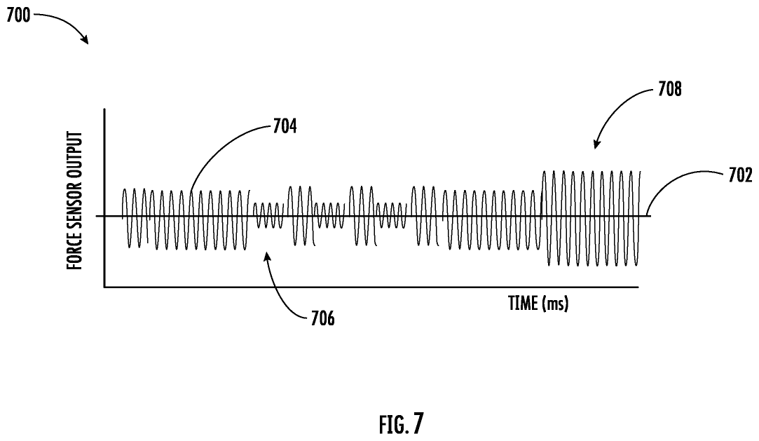

FIG. 6 illustrates working of the fluid sensor 100, in an assembled state, in accordance with an example embodiment of the present disclosure. In operation, the ultrasonic transducer 202 emits radiations or ultrasonic signals 602 from the emitting face 402. The first fixture 312 allows focusing the ultrasonic signals 602 on a region on the flow tube 106. The ultrasonic signals 602 penetrate the flow tube 106 and propagate through the flow tube 106. The ultrasonic signals 602 are received by the receiving face 504 of the force sensor 204. The force sensor 204 detects the ultrasonic signals 602 based on deformation of the diaphragm and converts into electrical signals. Under normal conditions, when there is no bubble or an occlusion in the flow tube 106, the ultrasonic signals 602 are detected without any variation. However, in a condition, when there is a bubble or an occlusion, variations in the signals are detected by the force sensor 204. The details of the variations in the signals detected in response to the bubble or the occlusion event is described in detail with reference to FIG. 7. Based on the type of variations in the signals, the fluid sensor 100 detects bubble and the occlusion.

FIG. 7 illustrates a graphical representation 700 of an output signal wave sensed by a force sensor 204. The graphical representation 700 shows the force sensor output and time plotted on y-axis and x-axis respectively. The output signal wave has a Direct Current (DC) component, such as baseline 702 and an Alternating Current (AC) component, such as amplitude 704.

The fluid sensor 100 is configured to enable simultaneous monitoring of both the AC and DC components of the output signal. Such a configuration may effectively reduce the error rate of the sensor by compensating for unwarranted external forces that may affect the sensor's acoustic baseline and lead in inaccuracies. Such a shift of the sensor's acoustic baseline may be caused by factors such as, for example, tubing/plastic deformation, and temperature change. Configuring the components of the fluid sensor 100 in such a way that enables the coupling of the AC and DC components provides efficient and accurate characterization of flow within the flow tube 106.

The graphical representation 700 shows distorted output signal sensed by the force sensor 204, caused by the presence of the bubble or the occlusion within the flow tube 106. As described above, in a condition in which bubbles and/or the occlusion are present within the flow tube 106, the output signal may exhibit characteristics different from those of the output signal under normal baseline fluid flow conditions. The magnitude of AC response of the force sensor 204 reduces from established baseline for a given tube type and material, as shown in zone 706 of the output signal, when air bubble is present in the flow tube 106. For example, as shown in FIG. 7, the presence of air bubbles within the flow tube 106 may result in a signal shift of, for example about 5 mV, that is noticeably lower when measured in the presence of the air bubble.

In an instance, when the occlusion occurs, the pressure inside the flow tube 106 increases as a pump connected to the flow tube 106 continues pushing fluid within the flow tube 106. The flow tube 106 becomes more stiffer, allowing more acoustic energy coupling from air/tube interface. This results in increase of signal received by the force sensor 204 from baseline and increasing the amplitude, as shown in zone 708 of the output signal.

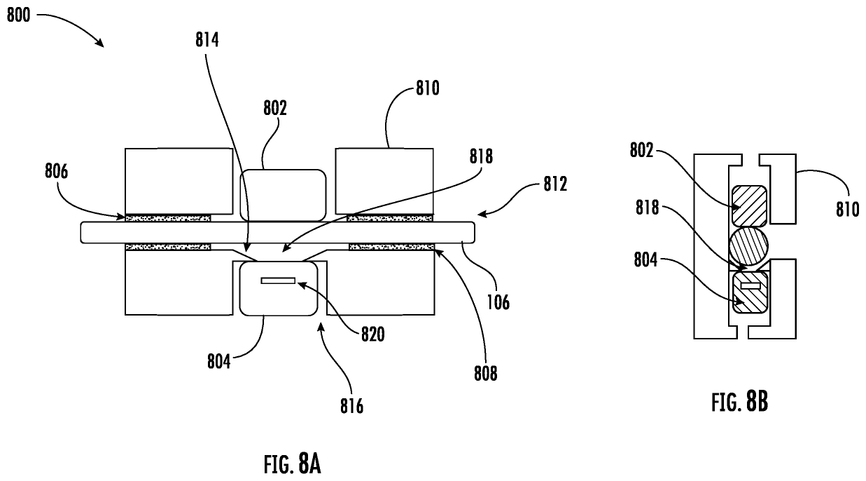

FIGS. 8A-8B illustrate various sectional views of another fluid sensor 800, in accordance with an example embodiment of the present disclosure. The fluid sensor 800 comprises an ultrasonic transducer 802, a force sensor 804 and cushioning elements 806 and 808. The ultrasonic transducer 802 and the force sensor 804 are disposed within a housing 810 having a channel 812. The ultrasonic transducer 802 and the force sensor 804 are aligned within the housing 810 to face one another, that is, an emitting face of the ultrasonic transducer 802 is facing towards a receiving face of the force sensor 804 such that waves or signals generated by the ultrasonic transducer 802 and emitted from the emitting face of the ultrasonic transducer 802 travel towards the receiving face of the force sensor 804. In such an exemplary configuration, the ultrasonic transducer 802 and the force sensor 804 are arranged to face a direction perpendicular to the length of the channel 812.

As shown in FIGS. 8A-8B, the flow tube 106 is received within the channel 812 of the housing 810. The cushioning elements 806 and 808 are affixed to the housing 810 and disposed between the housing 810 and the portion of the flow tube 106. In an example, the cushioning elements 806 and 808 are aligned such that the cushioning elements 806 and 808 hold the flow tube 106 within the channel 812 and minimize relative motion between the housing 810 and the flow tube 106. The ultrasonic transducer 802 is in contact and pressed against the portion of the flow tube 106. In an example, the ultrasonic transducer 802 is in contact with a predefined compression with the portion of the flow tube 106 to provide optimum coupling efficiency to the ultrasonic signals propagating through the flow tube 106. For instance, the flow tube 106 is squeezed in the channel 812 by about 20 to 40% of an outer diameter of the flow tube 106.

The housing 810 defines a fixture 814 and a cavity 816 in which the force sensor 804 is disposed. The fixture 814 is positioned adjacent to the receiving face of the force sensor 804 and extends along a boundary of the cavity 816. In one example, the fixture 814 is of a conical shape. The force sensor 804 is spaced apart from the portion of the flow tube 106 to define a gap filled with a gel filling 818 between the force sensor 804 and the flow tube 106. The gel filling 818 facilitates proper butting with the flow tube 106 and provides a solid path for the ultrasonic signals to reach the force sensor 804.

In an example, the fixture 814 of suitable dimensions is inserted into a silicon sense die 820 along with a can package and filled with the gel filling 818 after wire bonding to make contacts. In another example, the gel filling 818 and the fixture 814 are attached to the force sensor 804. The fixture 814 and the gel filling 818 improve collection of the ultrasonic signals emitted by the ultrasonic transducer 802 and propagated through the portion of the flow tube 106 by focusing maximum ultrasonic signals on the region of the force sensor 804. Focusing the ultrasonic signals on to the region of the force sensor 806 improves a field of view of the force sensor 804 and improves detection of all sizes of bubbles and differentiation between medium sized and large sized bubbles. In an example, small sized bubbles are detectable by the force sensor 804.

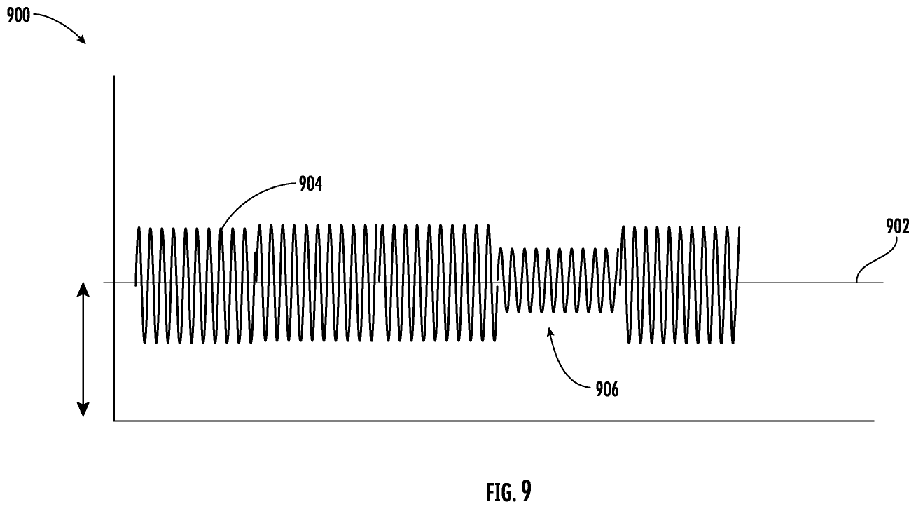

FIG. 9 illustrates a graphical representation 900 of an output signal wave sensed by the force sensor 804 of the fluid sensor 800. The graphical representation 900 shows the force sensor output and time plotted on y-axis and x-axis respectively. The output signal wave has a DC component, such as a baseline 902 and an AC component, such as an amplitude 904.

The fluid sensor 800 is configured to enable simultaneous monitoring of both the AC and DC components of the output signal. The graphical representation 900 shows distorted output signal sensed by the force sensor 804, caused by the presence of a bubble or more than one bubble within the flow tube 106. As described above, in a condition in which bubbles are present within the flow tube 106, the output signal may exhibit characteristics different from those of the output signal under normal baseline fluid flow conditions. For example, as shown in FIG. 9, the AC component amplitude is within a range of 0 millivolts (mV) to 5 mV, where 0 mV is indicative of a DC level from static force acting on the fluid sensor 800. The magnitude of AC response of the force sensor 804 reduces from established baseline, as shown in zone 906 of the output signal, when air bubble is present in the flow tube 106. In an example, the DC component for static force range is 0 mV to 20 mV in an unamplified condition. The DC level changes when an occlusion happens.

Signal excursion from the constant base line to change in amplitude is indication of bubbles. The percentage change is indication of size, where higher percentage dip indicates bigger bubble. The signal output also depends upon the flow rate or speed of the bubble. For instance, if the speed of bubble flow is slow, the duration of dip in the output signal is longer. The variation is measured based relative change from the prevailing base line.

In an instance, when a train of bubbles passes through the flow tube 106 with low to high average velocity, the sensor output has momentary shifts of amplitude from baseline, and varies based on speed of change depending on sensor response time for high flow rate of bubbles.

In an example, having high flow rate of 500 mL/hr for bubbles flow, a bubble of size less than sensor diameter requires about 5 μs and the output signal changes to a low condition for that time and returns back to the baseline before successive bubble arrives. In another example, when the sensor response time is faster, for instance, 1 μs, then the change in the sensor output can be detected instantly.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments, but not other embodiments.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present disclosure are disclosed herein; however, it is to be understood that the disclosed embodiments are merely exemplary, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

While it is apparent that the illustrative embodiments herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present disclosure.

What is claimed is:

1. A fluid sensor comprising:
a housing configured to hold a portion of a flow tube, the housing defining:
a first cavity; and
a first fixture extending along a boundary of the first cavity; and
an ultrasonic transducer, wherein the ultrasonic transducer is housed within the first cavity, the ultrasonic transducer having an emitting face configured to emit ultrasonic signals, and the emitting face is configured to face the portion of the flow tube,
wherein the first fixture is configured to focus the ultrasonic signals on a region on the portion of the flow tube.

2. The fluid sensor of claim 1, wherein the housing defines a second cavity, wherein a force sensor is housed within the second cavity, the force sensor having a receiving face configured to receive the ultrasonic signals for detecting a change in amplitude of the ultrasonic signals.

3. The fluid sensor of claim 2, wherein the housing defines a second fixture extending along a boundary of the second cavity, wherein the second fixture is configured to focus the ultrasonic signals from the ultrasonic transducer on a region of a receiving face of the force sensor.

4. The fluid sensor of claim 2, wherein the housing defines a channel between the first cavity and the second cavity, wherein the channel is to receive the portion of the flow tube.

5. The fluid sensor of claim 1, wherein the emitting face of the ultrasonic transducer is spaced apart from the portion of the flow tube to collectively define a gap between the ultrasonic transducer and the flow tube, when the portion of the flow tube is received within the channel of the housing.

6. The fluid sensor of claim 2, wherein the receiving face of the force sensor is spaced apart from the portion of the flow tube to collectively define a gap between the force sensor and the flow tube, when the portion of the flow tube is received within the channel of the housing.

7. The fluid sensor of claim 4 further comprises a cushioning element affixed to a portion of the housing, wherein the cushioning element is configured to hold the portion of the flow tube in the channel when the portion of the flow tube is received by the channel.

8. A fluid sensor comprising:
a housing defining a channel, the channel configured to receive a portion of a flow tube, the housing comprising a first cavity;
an ultrasonic transducer, housed within the first cavity, the ultrasonic transducer having an emitting face configured to emit ultrasonic signals, and the emitting face is configured to face the portion of the flow tube; and
a cushioning element affixed to a portion of the housing, wherein the cushioning element is configured to hold the portion of the flow tube in the channel when the channel receives the portion of the flow tube.

9. The fluid sensor of claim 8, wherein the housing defines a second cavity, wherein a force sensor is housed within the second cavity, the force sensor having a receiving face configured to receive the ultrasonic signals for detecting a change in amplitude of the ultrasonic signals.

10. The fluid sensor of claim 8, wherein the emitting face of the ultrasonic transducer is spaced apart from the portion of the flow tube to collectively define a gap between the ultrasonic transducer and the flow tube, when the portion of the flow tube is received within the channel of the housing.

11. The fluid sensor of claim 8, wherein the housing defines a first fixture extending along a boundary of the first cavity, wherein the first fixture is configured to focus the ultrasonic signals on a region on the portion of the flow tube.

12. The fluid sensor of claim 9, wherein the housing defines a second fixture extending along a boundary of the second cavity, wherein the second fixture is configured to focus the ultrasonic signals propagated through the portion of the flow tube on a region of the receiving face of the force sensor.

13. The fluid sensor of claim 11, wherein the first fixture has a conical shape.

14. The fluid sensor of claim 8, wherein the emitting face of the ultrasonic transducer is spaced apart from the portion of the flow tube to collectively define a gap between the ultrasonic transducer and the flow tube, when the portion of the flow tube is received within the channel of the housing.

15. A fluid sensor comprising:
a housing defining a channel, and a fixture, wherein the channel is configured to receive a portion of a flow tube;
a force sensor disposed within the housing, the force sensor having a receiving face configured to receive ultrasonic signals for detecting a change in amplitude of the ultrasonic signals, wherein the ultrasonic signals propagate through the portion of the flow tube prior to receiving by the force sensor; and
the fixture is disposed adjacent the receiving face of the force sensor, wherein the fixture is configured to focus the ultrasonic signals on a region of the receiving face of the force sensor,
wherein the force sensor is configured to:
detect presence of an air bubble based on decrease in amplitude of the ultrasonic signals; and
detect an occlusion based on increase in amplitude of the ultrasonic signals.

16. The fluid sensor of claim 15, wherein the housing defines a first cavity and a second cavity on opposite sides of the channel,
wherein an ultrasonic transducer is disposed within the first cavity, the ultrasonic transducer having an emitting face configured to emit the ultrasonic signals, and the emitting face is configured to face the portion of the flow tube,
wherein the force sensor is disposed within the second cavity of the housing, and the fixture is disposed along a boundary of the second cavity, wherein the air bubble is a small sized bubble.

17. The fluid sensor of claim 16 further comprising a gel filling disposed in between the portion of the flow tube and the force sensor.

18. The fluid sensor of claim 15 further comprising a cushioning element affixed to a portion of the housing, wherein the cushioning element is configured to hold the portion of the flow tube in the channel when the channel receives the portion of the flow tube.

19. The fluid sensor of claim 15, wherein the fixture has a conical shape.

20. The fluid sensor of claim 15, wherein the receiving face of the force sensor is spaced apart from the portion of the flow tube to collectively define a gap between the force sensor and the flow tube, when the portion of the flow tube is received within the channel of the housing.
